(19) United States
(12) Patent Application Publication
(10) Pub. No.: US 2021/0020354 A1
(43) Pub. Date: Jan. 21, 2021

(54) INDUCTOR

(71) Applicant: Murata Manufacturing Co., Ltd., Kyoto-fu (JP)

(72) Inventor: Ryota WATANABE, Nagaokakyo-shi (JP)

(73) Assignee: Murata Manufacturing Co., Ltd., Kyoto-fu (JP)

(21) Appl. No.: 16/929,323

(22) Filed: Jul. 15, 2020

(30) Foreign Application Priority Data
Jul. 19, 2019 (JP) 2019-133829

(51) Int. Cl. H01F 27/28; H01F 27/24; H01F 27/29; H01F 27/32; H01F 41/063; H01F 41/02

(52) U.S. Cl. CPC H01F 27/2823; H01F 27/24; H01F 41/0246; H01F 27/323; H01F 41/063; H01F 27/29

(57) ABSTRACT

An inductor includes an element assembly and a pair of outer electrodes. The element assembly includes a coil and a magnetic body. The coil includes a winding portion in which conductive wires each having a coating layer are spirally wound in two stages connected at their innermost segments and a pair of extension portions extended from their outermost segments in the stages of the winding portion. The magnetic body has a mounting surface, is made of magnetic powder and resin, and seals the coil such that the mounting surface is approximately parallel with a winding axis of the winding portion. The outer electrodes are disposed on the mounting surface. Each of the extension portions includes a first region and a second region. The element assembly has a recess portion allowing the first regions and an outer surface of the winding portion positioned between the first regions to be exposed.

### CROSS-REFERENCE TO RELATED APPLICATION

This application claims benefit of priority to Japanese Patent Application No. 2019-133829, filed Jul. 19, 2019, the entire content of which is incorporated herein by reference.

### BACKGROUND

### Technical Field

The present disclosure relates to an inductor and in particular to a surface-mount inductor.

### Background Art

Surface-mount inductors including a coil and a magnetic body that seals the coil are widely known. One example of them is an inductor in which the winding axis of the coil is substantially parallel with a mounting surface, an extension portion of the coil is extended to the mounting surface, and an outer electrode is formed thereon, as described, for example, International Publication No. 2017/188102. In the inductor described in that patent document, the magnetic body is formed by arranging a preform made of magnetic powder and resin, incorporating the coil in a mold, and compressing and heating it.

The magnetic powder has an insulating coating, and it is known that the insulating properties of the magnetic body formed by heating and compressing inside the mold decreases especially in a region near the inner surface of the mold. Thus, the insulating properties between outer electrodes in the inductor decrease, and if the inductor is used for applying a relatively large current, sufficient withstand voltage performance may not be obtainable.

### SUMMARY

Accordingly, the present disclosure provides a surface-mount inductor having sufficient withstand voltage performance and a method for manufacturing the same.

According to preferred embodiments of the present disclosure, an inductor includes an element assembly and a pair of outer electrodes.

The element assembly includes a coil and a magnetic body. The coil includes a winding portion in which conductive wires each having a coating layer are spirally wound in two stages connected at their innermost segments and a pair of extension portions extended from their outermost segments in the stages of the winding portion. The magnetic body has a mounting surface, is made of magnetic powder and resin, and seals the coil such that the mounting surface is approximately parallel with a winding axis of the winding portion.

The pair of outer electrodes are disposed on the mounting surface.

Each of the pair of extension portions includes a first region extended from the outermost segment in the winding portion toward the mounting surface and a second region continuous with the first region. The first regions in the pair of extension portions are opposed to each other. The second regions in the pair of extension portions are bent in a direction in which they are separated from each other such that they are exposed to the mounting surface.

The pair of outer electrodes are disposed on the second regions, respectively, in the pair of extension portions where the coating layers are removed.

The element assembly has a groove-like recess portion that allows the opposed first regions and an outer surface of the winding portion positioned between the opposed first regions to be exposed.

According to preferred embodiments of the present disclosure, a method for manufacturing an inductor is provided. The method includes a coil forming step of spirally winding conductive wires each having a coating layer in two stages connected at their innermost segments to form a winding portion, and extending outermost segments in the stages of the winding portion in the same direction such that they are opposed to each other to form first regions, bending end portions of the first regions in a direction in which they are separated from each other to form second regions. The first regions and the second regions constitute a pair of extension portions, and thus form a coil including the winding portion and the pair of extension portions. The method also includes a preform shaping step of making a first preform and a second preform out of magnetic powder and resin, the first preform including a bottom section, a projecting portion at an approximately central portion of the bottom section, and a plurality of wall sections standing upward at an outer area of the bottom section. One of the wall sections has a cut-out portion conforming to dimensions between the pair of extension portions, an outer surface of the wall section has the cut-out portion constituting a mounting surface, and the second preform has a planar shape and has a side surface with a cut-out portion conforming to the dimensions between the pair of extension portions. The method further includes an element-assembly shaping step of inserting the projecting portion in the first preform into a hollow section in the winding portion in the coil, extending the opposed first regions in the coil outside the first preform through the cut-out portion, housing the coil in the first preform such that the second regions in the coil are exposed to the mounting surface, putting the second preform on the first preform with the coil housed therein like a lid to form an assembly, arranging the assembly in a mold, and heating and compressing the assembly, the mold including a projecting portion and a surface section. The projecting portion is in contact with the opposed first regions and with an outer surface of the winding portion positioned between the opposed first regions, and the surface section is in contact with outer surfaces of the second regions. The method also includes an electrode forming step of removing the coating layers of the second regions in part and forming an outer electrode on the second regions where the coating layers are removed.

According to the above-described embodiments, the surface-mount inductor having sufficient withstand voltage performance and the method for manufacturing the same can be provided.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1A is a side view that schematically illustrates an external shape of an inductor according to a first embodiment of the present disclosure;

FIG. 1B is a bottom view that schematically illustrates a mounting surface side of the inductor as seen from the arrows A-A in FIG. 1A;

FIG. 1C is a side sectional view that schematically illustrates a cross section B-B in FIG. 1B;

FIG. 2 is an exploded perspective view that schematically illustrates a coil and preforms for forming the inductor according to the first embodiment of the present disclosure;

FIG. 3A is a side view that schematically illustrates an external shape of an inductor according to a second embodiment of the present disclosure;

FIG. 3B is a bottom view that schematically illustrates the inductor as seen from the arrows E-E in FIG. 3A;

FIG. 3C is a side sectional view that schematically illustrates a cross section F-F in FIG. 3B;

FIG. 4A is a side view that schematically illustrates an external shape of an inductor according to a third embodiment of the present disclosure;

FIG. 4B is a bottom view that schematically illustrates the inductor as seen from the arrows C-C in FIG. 4A; and

FIG. 4C is a side sectional view that schematically illustrates a cross section D-D in FIG. 4B.

### DETAILED DESCRIPTION

Embodiments for carrying out the present disclosure are described below with reference to the drawings. An inductor described below is for embodying the technical idea of the present disclosure, and the present disclosure is not limited to the inductor below unless otherwise specified.

In the drawings, members having the same function may have the same reference numerals. In consideration of description of main points or facilitation of understanding, configurations may be divided into embodiments or examples for the sake of convenience, and the configurations illustrated in different embodiments may be replaced or combined in part. In subsequent embodiments, description of matters common to the foregoing is omitted, and only differences are described. In particular, similar operational advantages from similar configurations are not mentioned in succession in each embodiment or example. The sizes, positional relationships, and the like of members illustrated in the drawings may be exaggerated for the sake of clear description.

### First Embodiment

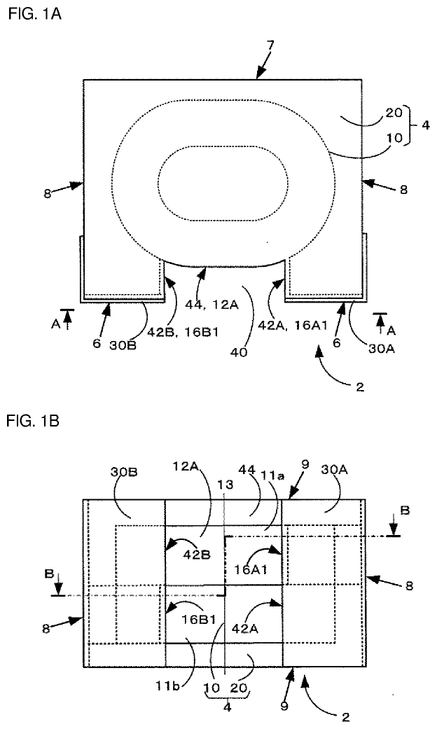

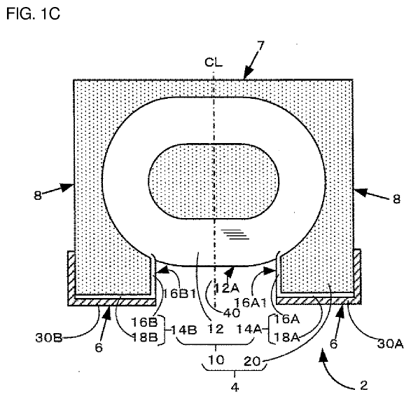

First, an inductor according to a first embodiment of the present disclosure is described with reference to FIGS. 1A, 1B, and 1C. FIG. 1A is a side view that schematically illustrates an external shape of the inductor according to the first embodiment of the present disclosure. FIG. 1B is a bottom view that schematically illustrates a mounting surface side of the inductor as seen from the arrows A-A in FIG. 1A. FIG. 1C is a side sectional view that schematically illustrates a cross section B-B in FIG. 1B. In FIG. 1C, the left-hand and right-hand illustrations with respect to a center line CL are cross sections at different heights.

An inductor 2 according to the present embodiment includes an element assembly 4 having an approximately rectangular parallelepiped shape and including a coil 10 and a magnetic body 20 sealing the coil 10. The magnetic body 20 is made of magnetic powder and resin. The inductor 2 is a surface-mount inductor having a mounting surface 6, an upper surface 7 opposed to the mounting surface 6, opposed end surfaces 8 substantially perpendicular to the mounting surface 6, and opposed side surfaces 9 substantially perpendicular to the mounting surface 6 and end surfaces 8. The magnetic powder is composed of insulating-coated metal magnetic powder. The resin is composed of thermosetting resin having the insulating properties. The magnetic powder may be a mixture of metal magnetic powders having different grain sizes or may be a mixture of metal magnetic powders having different compositions.

The element assembly 4 is formed by incorporating the coil 10 into a preform made of the magnetic powder and resin and by heating and compressing the combination inside a mold, as described below. The preforms with the coil 10 incorporated therein integrally shaped by the heating and compressing constitute the magnetic body 20.

The element assembly 4 including the coil 10 and the magnetic body 20 sealing it has an approximately rectangular parallelepiped external shape. An example range of the size of the element assembly 4 may be as follows: the length in the longitudinal direction is equal to or larger than about 1.6 mm and equal to or smaller than about 3.2 mm (i.e., from about 1.6 mm to about 3.2 mm); the length in the transverse direction is equal to or larger than about 0.8 mm and equal to or smaller than about 2.5 mm (i.e., from about 0.8 mm to about 2.5 mm); and the height is equal to or larger than about 0.5 mm and equal to or smaller than about 2.5 mm (i.e., from about 0.5 mm to about 2.5 mm). The size is not limited to that example.

The magnetic body 20 is formed by pressing and shaping preforms made of the mixture of magnetic powder and resin. An example filling factor of the magnetic powder in the mixture may be equal to or larger than about 60 wt %, and preferably, equal to or larger than about 80 wt %. Examples of the magnetic powder may include iron-based metal magnetic powder, such as powder made of Fe, Fe—Si—Cr, Fe—Ni—Al, Fe—Cr—Al, Fe—Si, Fe—Si—Al, Fe—Ni, or Fe—Ni—Mo, metal magnetic powder based on other compositions, metal magnetic powder made of amorphous or the like, magnetic powder whose surface is covered with an insulating material, such as glass, metal magnetic powder whose surface is modified, and minute metal magnetic powder on the order of nanometers. Examples of the resin may include thermosetting resin, such as epoxy resin, polyimide resin, or phenol resin, and thermoplastic resin, such as polyethylene resin or polyamide resin.

The coil 10 is a so-called alpha winding coil of conductive wires having a substantially rectangular cross section. More specifically, the coil 10 includes a winding portion 12 in which substantially rectangular flat wires (hereinafter referred to simply as rectangular flat wires) each having a coating layer are spirally wound in two stages connected at their innermost segments and a pair of extension portions 14A and 14B extended from their outermost segments of the rectangular flat wires in the stages of the winding portion 12. In the present embodiment, a winding axis 13 of the winding portion 12 in the coil 10 is approximately parallel with the mounting surface 6, and the coil 10 is sealed inside the magnetic body 20. Each of the rectangular flat wires may have a fusing layer for maintaining the winding coil shape on the coating layer.

Example dimensions of the rectangular flat wire constituting the coil 10 may be as follows: the length in the width direction is equal to or larger than about 150 μm and equal to or smaller than about 600 μm (i.e., from about 150 μm to about 600 μ; and the thickness is equal to or larger than about 20 μm and equal to or smaller than about 200 μm (i.e., from about 20 μm to about 200 μm). The dimensions are not limited to that example. Furthermore, a circular wire having a substantially circular cross section may also be used, and a wire in which an end of the circular wire is crushed to a substantially flat shape may also be used.

Next, the pair of extension portions 14A and 14B extended from the winding portion 12 are described mainly with reference to FIG. 1C. The right-hand region in FIG. 1C illustrates a cross section at the height of an upper stage 11a of the winding portion 12 in FIG. 1B from which the first extension portion 14A is extended, whereas the left-hand region illustrates a cross section at the height of a lower stage 11b of the winding portion 12 in FIG. 1B from which the second extension portion 14B is extended.

The first extension portion 14A includes a first region 16A extended from the outermost segment in the upper stage 11a of the winding portion 12 and a second region 18A being an end portion continuous with the first region 16A. Similarly, the second extension portion 14B includes a first region 16B extended from the outermost segment in the lower stage 11b of the winding portion 12 and a second region 18B being an end portion continuous with the first region 16B.

In the illustrated example, the first region 16A in the first extension portion 14A and the first region 16B in the second extension portion 14B are opposed to each other. More specifically, an outer surface (wider surface of the rectangular flat wire) 16A1 of the first region 16A in the first extension portion 14A and an outer surface (wider surface of the rectangular flat wire) 16B1 of the first region 16B in the second extension portion 14B are approximately parallel with each other and are not aligned with each other. The arrangement is not limited to that example, and each of the regions may be inclined to some degree. The first regions 16A and 16B, which extend linearly in the above-described example, may also be slightly curved.

The second region 18A in the first extension portion 14A and the second region 18B in the second extension portion 14B are bent from the first regions 16A and 16B to approximately 90 degrees in a direction in which they are separated from each other such that they are exposed to the mounting surface 6. Here, the mounting surface 6 is a surface at which the inductor 2 is placed on a substrate or the like, and in the present embodiment, it corresponds to outer surfaces of outer electrodes 30A and 30B described below.

In the illustrated example, the second regions 18A and 18B are bent approximately perpendicularly to the first regions 16A and 16B, respectively. The shape is not limited to the above-described example. When the second regions 18A and 18B are bent at least in the direction in which they are separated from each other such that they are exposed to the mounting surface 6, the second regions 18A and 18B may not be bent approximately perpendicularly to the first regions 16A and 16B, respectively, and the second regions 18A and 18B may not be bent in a direction opposed to the end surfaces 8. The second regions 18A and 18B may preferably extend linearly such that they are exposed along the mounting surface 6.

The coating layer of the rectangular flat wire is removed at least in part on each of the outer surfaces of the second regions 18A and 18B (surfaces opposite to the magnetic body 20) exposed to the mounting surface 6, and the pair of outer electrodes 30A and 30B are formed on the second regions 18A and 18B where the coating layers are removed. Thus, the outer electrode 30A and the second region 18A in the extension portion 14A are electrically connected, and the outer electrode 30B and the second region 18B in the extension portion 14B are electrically connected. In the illustrated example, the outer electrodes 30A and 30B extend not only on the mounting surface 6 but also to the side surfaces 9 of the magnetic body 20. Thus, the contact area of soldering when the inductor 2 is mounted can be increased. The position is not limited to the above-described example. The outer electrodes 30A and 30B may be disposed only on the mounting surface 6.

The outer electrodes 30A and 30B can be formed by applying conductive paste on the regions of the mounting surface 6 including the second regions 18A and 18B where the coating layers are removed and the side surfaces 9 and can also be formed by performing plating thereon.

(Groove-Like Recess Portion)

The inductor 2 according to the present embodiment has a groove-like recess portion 40 in the bottom surface of the element assembly 4, the groove-like recess portion 40 allowing the opposed first regions 16A and 16B in the extension portions and an outer surface 12A of the winding portion 12 between the first regions 16A and 16B to be exposed. The groove-like recess portion 40 extends through between the opposed side surfaces 9.

Inner side surfaces 42A and 42B of the recess portion 40 may be flat or curved. A bottom surface 44 of the recess portion 40 may also be curved or flat, and it may preferably be continuous with the exposed outer surface 12A of the winding portion 12 such that no steps are present between them. In the above-described example, the inner side surfaces 42A and 42B are continuous with the exposed outer surfaces 16A1 and 16B1 of the first regions 16A and 16B such that no steps are present therebetween. At least a portion of the first regions 16A and 16B may be exposed from the element assembly and constitute a portion of the inner side surfaces 42A and 42B in the recess portion 40. A portion of the outer surface 12A of the winding portion 12 may be exposed from the element assembly and constitute a portion of the bottom surface 44.

In all of the above-described cases, the region surrounded by both the inner side surfaces 42A and 42B and the bottom surface 44 is space in which magnetic powder is absent. The gap between the pair of the outer electrodes 30A and 30B has a sufficient insulating distance by the presence of the space defined by the groove-like recess portion 40.

In known cases, for an element assembly formed by heating and compressing inside a mold, the insulating properties of a magnetic body between a pair of outer electrodes may decrease, and sufficient withstand voltage performance between the outer electrodes may not be obtainable. For example, although the inductor needs to have withstand voltage performance of about 30 volts or more, such performance may be unachievable.

In the present embodiment, because of the groove-like recess portion 40, the magnetic powder is absent between the pair of outer electrodes 30A and 30B, and the outer electrodes 30A and 30B are insulated by air. Accordingly, the surface-mount inductor having sufficient withstand voltage performance can be provided.

The groove-like recess portion 40A can provide a further advantage in that if warpage occurs in a substrate on which the inductor 2 is mounted, contact with the substrate having a convex portion resulting from the warpage can be avoided by the recess portion 40 present between the outer electrodes 30A and 30B, and the resistance of the inductor 2 to flection of the substrate when it is mounted can be improved.

(Method For Manufacturing Inductor)

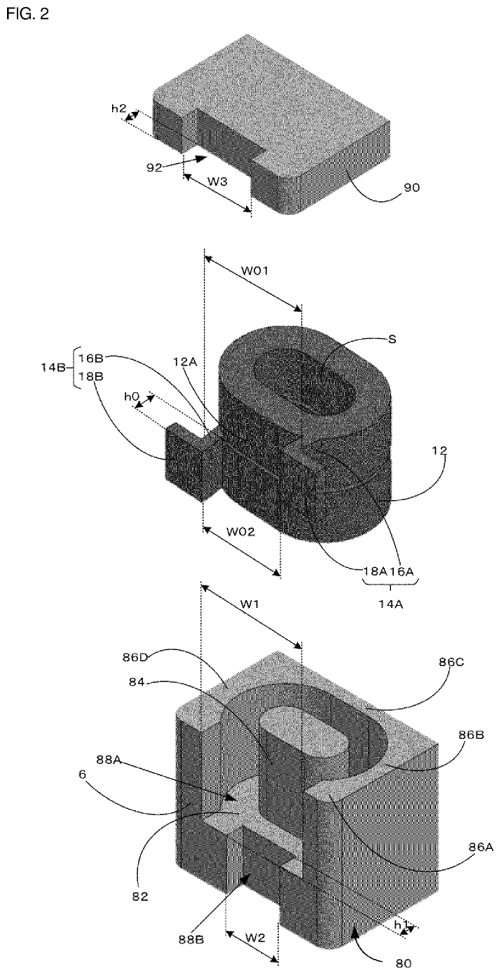

Next, a method for manufacturing an inductor is described with reference to FIG. 2 by using the inductor 2 according to the first embodiment as an example. FIG. 2 is an exploded perspective view that schematically illustrates the coil and preforms for forming the inductor according to the first embodiment of the present disclosure.

The coil 10 is illustrated in the center of FIG. 2, a first preform 80 is illustrated below the coil 10, and a second preform 90 is illustrated above the coil 10. As described below, in a state where the coil 10 is incorporated in the first preform 80 and the second preform 90 is put thereon like a lid, the combination is heated and compressed inside a mold, and thus the element assembly 4 illustrated in FIGS. 1A to 1C is formed.

(1) Coil Forming Step

First of all, a coil forming step for forming the coil 10 is described.

First, rectangular flat wires each having a coating layer are prepared, the rectangular flat wires are spirally wound in two stages connected at their innermost segments, and thus the winding portion 12 is formed. Then, their outermost segments in the stages of the winding portion 12 are extended in the same direction such that they are opposed to each other, and thus the first regions 16A and 16B are formed. The end portions of the first regions 16A and 16B are bent in a direction in which they are separated from each other, and thus the second regions 18A and 18B are formed. In that way, the coil 10 including the winding portion 12 and the pair of extension portions 14A and 14B composed of the first regions 16A and 16B and the second regions 18A and 18B can be formed.

(2) Preform Shaping Step

Next, a preform shaping step for shaping the first and second preforms 80 and 90 is described.

First, a mixture of magnetic powder and resin is charged into a mold for shaping the first preform 80. The mixture of magnetic powder and resin is pressed in the mold with a pressure of about 1 t/cm² to 10 t/cm² for about several seconds to several minutes, and thus the first preform 80 is shaped. The mixture of magnetic powder and resin may be pressed and shaped in a state where it is heated at a temperature equal to or higher than a softening temperature of the resin (e.g., about 60° C. to about 150° C.). After that, the mixture may be cured by heat at a temperature equal to or higher than a curing temperature of the resin (e.g., about 100° C. to about 220° C.), and thus the first preform 80 can be obtained. In another case, the mixture may be semi-cured. In that case, it can be semi-cured at an adjusted temperature (e.g., about 100° C. to about 220° C.) for an adjusted curing time (about 1 min to about 60 min.). By a similar way, the second preform 90 can also be shaped.

Thus, the first preform 80 including a bottom section 82, a projecting portion 84 at an approximately central portion of the bottom section 82, and wall sections 86A to 86D standing upward at the outer area of the bottom section 82 can be obtained. The external shape of the projecting portion 84 conforms to the internal shape of a hollow section S of the coil 10. Among the four wall sections 86A to 86D in the first preform 80, the single wall section 86A has cut-out portions 88A and 88B conforming to the dimensions between the pair of extension portions 14A and 14B. The outer surface of the wall section 86A constitutes the mounting surface 6.

The second preform 90 has a planar shape and includes a cut-out portion 92 conforming to the dimensions between the pair of extension portions 14A and 14B in one side surface. The cut-out portions 88A and 88B and the cut-out portion 92 constitute the groove-like recess portion 40 in the element assembly 4.

More specifically, the width dimension W1 of the cut-out portion 88A in the first preform 80 is set at a value approximately the same as the distance W01, which is the sum of the distance between the opposed first regions 16A and 16B and the double of the thickness of the rectangular flat wire. The width dimension W2 of the cut-out portion 88B is set at a value approximately the same as the distance W02 between the opposed first regions 16A and 16B. The width dimension W3 of the cut-out portion 92 in the second preform 90 is set at a value approximately the same as the distance W02 between the opposed first regions 16A and 16B, as with the width dimension W2.

Although the cut-out portion 88A is illustrated as a cut having a fixed width dimension in FIG. 2, the width dimension below the region where the extension portion 14A in the upper stage of the coil 10 is present may be smaller than W1. Similarly, a portion of the second preform 90 may also be extended downward to cover the area above the region where the extension portion 14B in the lower stage of the coil 10 is present. The mixture of magnetic powder and resin may also be charged to a predetermined position in the mold including those regions.

The depth h1 of the cut-out portions 88A and 88B and the depth h2 of the cut-out portion 92 are approximately the same as the distance h0 from the outer segment surface of the winding portion 12 in the coil 10 to the outer surface of each of the second regions 18A and 18B. With the above-described width dimensions W1, W2, and W3 and depths h1 and h2, the outer surface of the magnetic body 20, which constitutes the mounting surface 6, can be approximately flush with the outer surfaces of the second regions 18A and 18B.

(3) Element-Assembly Shaping Step

Next, an element-assembly shaping step for shaping the element assembly 4 including the coil 10 and the magnetic body 20 is described.

First, the coil 10 is placed on the first preform 80 such that the projecting portion 84 in the first preform 80 is inserted into the hollow section S in the winding portion 12 in the coil 10. Then, the coil 10 is housed in the first preform 80 such that the opposed first regions 16A and 16B are extended out through the cut-out portion 88A and the second regions 18A and 18B are exposed to the mounting surface 6. The second preform 90 is put on them like a lid, and then the resulting assembly is arranged inside a mold.

The assembly of the first preform 80, the coil 10, and the second preform 90 may be arranged inside the mold after the assembly is formed. The assembly may be formed while each of the first preform 80, the coil 10, and the second preform 90 is arranged in the mold.

The mold is composed of a die and a punch. The die has a flat bottom and a die hole whose internal shape is slightly larger than the bottom section 82 in the first preform 80. In the die hole, a projecting portion corresponding to the opposed first regions 16A and 16B and the outer surface 12A of the winding portion 12 positioned between the opposed first regions 16A and 16B is disposed.

After the assembly is arranged inside that die hole, it is pressed with a pressure of about 100 kg/cm² to about 500 kg/cm² by using the punch in a state where it is heated at a temperature equal to or higher than the softening temperature of the resin (e.g., about 60° C. to about 150° C.), and it is heated at a temperature equal to or higher than the curing temperature of the resin (e.g., about 100° C. to about 220° C.) and shaped and cured. In that way, the element assembly 4 in which the first preform 80, the coil 10, and the second preform 90 are integrated is formed. The curing may be performed after the shaping.

By the above-described shaping and curing, the element assembly 4 having the groove-like recess portion 40, which allows the opposed first regions 16A and 16B and the outer surface 12A of the winding portion 12 positioned between the opposed first regions 16A and 16B to be exposed, can be obtained.

(4) Electrode Forming Step

Next, an electrode forming step for forming the outer electrodes 30A and 30B is described.

First, the coating layers (specifically, coating layers and fusing layers) of the outer surfaces of the second regions 18A and 18B in the coil 10 are removed. The coating layers are removed by using physical means, such as a laser, blasting, or grinding. Next, the outer electrodes 30A and 30B are formed on the second regions 18A and 18B where the coating layers are removed. In the present embodiment, the outer electrodes 30A and 30B are formed on the two mounting surfaces 6, which are separated by the groove-like recess portion 40, and are also formed on their continuous end surfaces of the magnetic body 20. The outer electrodes 30A and 30B can be formed by the application of conductive paste. Furthermore, nickel plating and tin plating can also be applied on the conductive paste.

The outer electrodes 30A and 30B can also be formed by plating without the application of the conductive paste. In one such example case, they may be formed by copper plating, nickel plating applied thereon, and then tin plating applied on the nickel plating.

By the above-described manufacturing method, the inductor 2 can be provided including the element assembly 4 having the groove-like recess portion 40 allowing the opposed first regions 16A and 16B in the coil 10 and the outer surface 12A of the winding portion 12 positioned between the opposed first regions 16A and 16B to be exposed. Therefore, the surface-mount inductor 2 having sufficient withstand voltage performance is reliably obtainable.

### Second Embodiment

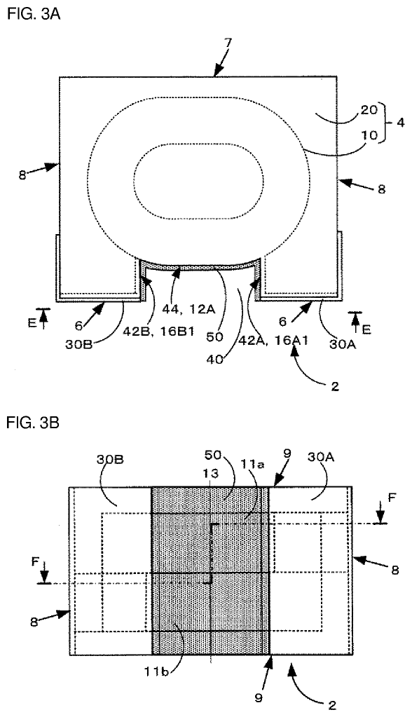

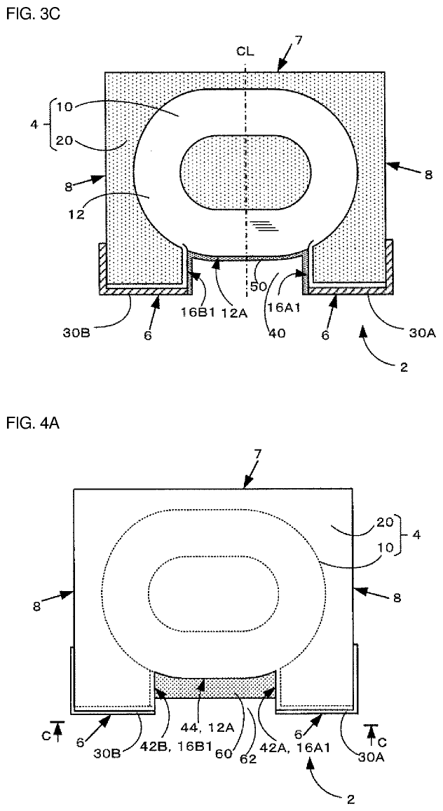

Next, an inductor according to a second embodiment of the present disclosure is described with reference to FIGS. 3A, 3B, and 3C. FIG. 3A is a side view that schematically illustrates an external shape of the inductor according to the second embodiment of the present disclosure. FIG. 3B is a bottom view that schematically illustrates the mounting surface side of the inductor as seen from the arrows E-E in FIG. 3A. FIG. 3C is a side sectional view that schematically illustrates a cross section F-F in FIG. 3B. As with FIG. 1C, the right-hand region in FIG. 3C illustrates a cross section corresponding to the upper stage 11a of the winding portion 12 in FIG. 3B from which the first extension portion 14A is extended, whereas the left-hand region illustrates a cross section corresponding to the lower stage 11b of the winding portion 12 in FIG. 3B from which the second extension portion 14B is extended.

The second embodiment differs from the first embodiment in that an insulating film 50 is disposed on both of the inner side surfaces of the recess portion 40 including the first regions 16A and 16B in the coil 10 and the bottom surface of the recess portion 40 including the outer surface 12A of the winding portion 12 in the coil 10, the inner side surfaces and bottom surface exposed in the first embodiment.

For example, the insulating film 50 can be formed by the application of insulating resin, such as polyimide-amide, to the exposed surfaces of both the inner side surfaces and bottom surface of the recess portion 40. An example thickness of the insulating film 50 may be in the range of about 20 μm to about 100 μm.

The withstand voltage performance between the outer electrodes 30A and 30B can be further improved by the insulating film 50. If warpage occurs in the substrate on which the inductor 2 is mounted, contact with the substrate having a convex portion resulting from the warpage can be avoided by the recess portion 40 present between the outer electrodes 30A and 30B, and the resistance of the inductor 2 to flection of the substrate when it is mounted can be improved.

### Third Embodiment

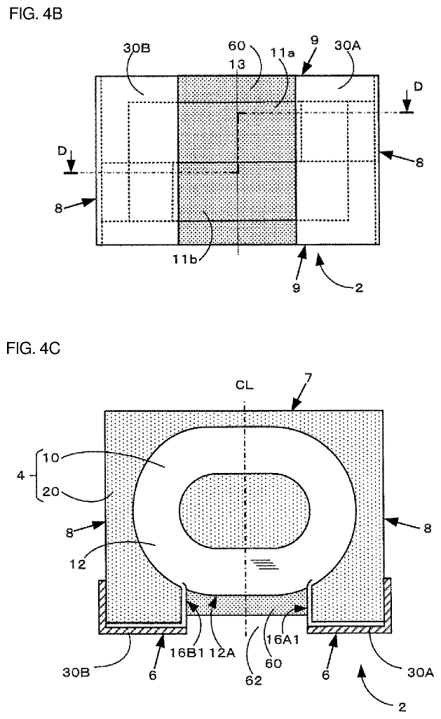

Next, an inductor according to a third embodiment of the present disclosure is described with reference to FIGS. 4A, 4B, and 4C. FIG. 4A is a side view that schematically illustrates an external shape of the inductor according to the third embodiment of the present disclosure. FIG. 4B is a bottom view that schematically illustrates the mounting surface side of the inductor as seen from the arrows C-C in FIG. 4A. FIG. 4C is a side sectional view that schematically illustrates a cross section D-D in FIG. 4B. As with FIG. 1C, the right-hand region in FIG. 4C illustrates a cross section corresponding to the upper stage 11a of the winding portion 12 in FIG. 4B from which the first extension portion 14A is extended, whereas the left-hand region illustrates a cross section corresponding to the lower stage 11b of the winding portion 12 in FIG. 4B from which the second extension portion 14B is extended.

The third embodiment differs from the first embodiment in that an insulator 60 is arranged in a region surrounded by both of the inner side surfaces of the recess portion 40 including the first regions 16A and 16B in the coil 10 and the bottom surface of the recess portion 40 including the outer surface 12A of the winding portion 12 in the coil 10, the inner side surfaces and bottom surface exposed in the first embodiment.

For example, in the above-described element-assembly shaping step, an insulating material, such as alumina, or an insulating thermosetting resin may be arranged in the region surrounded by the first regions 16A and 16B and the outer surface 12A of the winding portion 12 in the coil 10 inside the mold, they may be heated and pressed. In that way, the element assembly 4 including the insulator 60 can be formed.

The withstand voltage performance between the outer electrodes 30A and 30B can be further improved by the insulator 60.

Preferably, the insulator 60 may not be formed on the mounting surface 6, and a predetermined recess portion 62 may be present between the outer electrodes 30A and 30B. If warpage occurs in the substrate on which the inductor 2 is mounted, contact with the substrate having a convex portion resulting from the warpage can be avoided by the recess portion 62 present between the outer electrodes 30A and 30B, and the resistance of the inductor 2 to flection of the substrate when it is mounted can be improved. An insulating film may be formed on both of the inner side surfaces exposed in the region of the recess portion 62.

The embodiments of the present disclosure are described above. The disclosed content may be changed in details of the configuration. Combinations of elements, changes in the sequence, and the like in the embodiments can be made without departing from the scope and spirit of the present disclosure.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. An inductor comprising:
an element assembly including a coil and a magnetic body,
the coil including a winding portion in which a conductive wire having a coating layer is spirally wound in two stages continuously connected at an innermost segment of the winding portion and a pair of extension portions extended from outermost segments in the stages of the winding portion,
the magnetic body having a mounting surface, made of magnetic powder and resin, and sealing the coil such that the mounting surface is approximately parallel with a winding axis of the winding portion; and
a pair of outer electrodes disposed on the mounting surface,
wherein each of the pair of extension portions includes a first region extended from the outermost segment in the winding portion toward the mounting surface and a second region continuous with the first region,
the first regions in the pair of extension portions are opposed to each other,
the second regions in the pair of extension portions are bent in a direction in which the second regions are away from each other, and exposed to the mounting surface,
the pair of outer electrodes are disposed on the second regions, respectively, in the pair of extension portions where the coating layers are removed, and
the element assembly has a groove-like recess portion that allows the opposed first regions and an outer surface of the winding portion positioned between the opposed first regions to be exposed.

2. The inductor according to claim 1, wherein an insulating film is disposed on both inner side surfaces of the recess portion including the first regions and a bottom surface of the recess portion including the outer surface of the winding portion.

3. The inductor according to claim 1, wherein an insulator is provided in a region surrounded by both inner side surfaces of the recess portion including the first regions and a bottom surface of the recess portion including the outer surface of the winding portion.

4. A method for manufacturing an inductor, the method comprising:
forming a coil by
winding a conductive wire spirally having a coating layer in two stages continuously connected at an innermost segment of the conductive wire to form a winding portion,
extending two ends of the conductive wire at outermost segments in the stages of the winding portion in the same direction such that the two ends of the conductive wire are opposed to each other to form first regions, and
bending end portions of the first regions in a direction in which the end portions of the first regions are away from each other to form second regions, wherein the first regions and the second regions constitutes a pair of extension portions, and the coil includes the winding portion and the pair of extension portions is formed;
preform shaping by making a first preform and a second preform with magnetic powder and resin,
the first preform including a bottom section, a projecting portion at an approximately central portion of the bottom section, and a plurality of wall sections standing at an outer area of the bottom section, one of the wall sections having a cut-out portion whose dimension corresponds to a distance between the pair of extension portions, an outer surface of the wall section having the cut-out portion defining a mounting surface, and
the second preform having a planar shape and having a side surface with a cut-out portion whose dimension corresponds to a distance between the pair of extension portions;
shaping an element-assembly by
inserting the projecting portion in the first preform into a hollow section in the winding portion in the coil,
extending the opposed first regions in the coil outside the first preform through the cut-out portion,
housing the coil in the first preform such that the second regions in the coil are exposed to the mounting surface,
putting the second preform on the first preform with the coil housed therein to form an assembly,
arranging the assembly in a mold, and
heating and compressing the assembly in the mold,
wherein the mold includes a projecting portion and a surface section,
the projecting portion is in contact with the opposed first regions and in contact with an outer surface of the winding portion located between the opposed first regions,
the surface section is in contact with outer surfaces of the second regions; and
forming an electrode by
partially removing the coating layers of the second regions, and
forming an outer electrode on the second regions where the coating layers are removed.
